(19) United States
(12) Patent Application Publication
(10) Pub. No.: US 2024/0216870 A1
(43) Pub. Date: Jul. 4, 2024

(54) WATER PURIFIER FILTER CARTRIDGE OF SIMPLE STRUCTURE

(71) Applicant: Bluevua Inc., Spokane, WA (US)

(72) Inventors: Weiwu Zuo, Suzhou (CN); Yasu Wang, Suzhou (CN); Ling Yan, Suzhou (CN)

(21) Appl. No.: 18/093,116

(22) Filed: Jan. 4, 2023

(51) Int. Cl. B01D 69/04; B01D 61/02; B01D 61/08

(52) U.S. Cl. CPC B01D 69/046; B01D 61/025; B01D 61/08; B01D 2313/041; B01D 2313/08; B01D 2313/143; B01D 2313/201; B01D 2313/21; B01D 2313/44; B01D 2313/901

(57) ABSTRACT

The present utility model discloses a water purifier filter cartridge of simple structure, comprising a filter cartridge cylinder, wherein a central tube coaxial with the filter cartridge cylinder is disposed in the filter cartridge cylinder; a first cavity is formed in the central tube; a filter cartridge body is disposed outside the central tube; the filter cartridge body comprises an RO membrane and a pre-filtering membrane; the RO membrane is wound around the central tube; several water holes communicating the first cavity with the RO membrane are formed in the side wall of the central tube; the pre-filtering membrane is wound outside the RO membrane; a second cavity is formed between the pre-filtering membrane and the filter cartridge cylinder; a first water gap, a second water gap and a third water gap are formed in the top of the filter cartridge cylinder; the first water gap communicates with the first cavity; and the second water gap communicates with the second cavity. According to the water purifier filter cartridge of simple structure of the present utility model, the filter cartridge structure is simplified, the cost is lowered, connection of a water path of the filter cartridge in a water purifier is more convenient, mounting errors and omissions are reduced, the assembling efficiency is improved, and the structure of the water purifier filter cartridge is further improved.

### TECHNICAL FIELD

The present utility model relates to a water purifying plant, in particular to a water purifier filter cartridge of simple structure.

### BACKGROUND ART

The water purifier filter cartridge is an important structure in a water purifier for removing solid particles in water, killing bacteria and filtering out harmful chemical components. The common water purifier filter cartridge is usually of a composite structure where a pre-filter cartridge and a post-filter cartridge are stacked, and a keel is mounted in the middle. This filter cartridge is more complex in structure and requires the use of more plastic parts for separation, and consequently, the filter cartridge has more water inlets and outlets, with complex mounting, which improves the cost of the filter cartridge.

### SUMMARY OF THE UTILITY MODEL

Directing at the above technical problems, the present utility model aims to provide a water purifier filter cartridge of simple structure so as to simplify the structure and lower the cost.

In order to achieve the above purposes, the present utility model provides the following technical solution.

A water purifier filter cartridge of simple structure includes a filter cartridge cylinder, a central tube coaxial with the filter cartridge cylinder being disposed in the filter cartridge cylinder; a first cavity being formed in the central tube; a filter cartridge body being disposed outside the central tube; the filter cartridge body including an RO membrane and a pre-filtering membrane; the RO membrane being wound around the central tube; several water holes communicating the first cavity with the RO membrane being formed in the side wall of the central tube; the pre-filtering membrane being wound outside the RO membrane; a second cavity being formed between the pre-filtering membrane and the filter cartridge cylinder; a lower end cover being disposed at the bottom of the filter cartridge body, an upper end cover being disposed at the top of the filter cartridge body, and a third cavity being formed between the upper end cover and the filter cartridge body; a first water gap, a second water gap and a third water gap being formed in the top of the filter cartridge cylinder; the first water gap communicating with the first cavity: the second water gap communicating with the second cavity; and the third water gap communicating with the third cavity.

Preferably, a boss is disposed at the top of the filter cartridge cylinder, and the first water gap, the second water gap and the third water gap are formed in the boss.

Preferably, a first annular wall and a second annular wall coaxial with the filter cartridge cylinder are disposed in the boss, the upper portion of the central tube is inserted into the first annular wall, and a sealing ring is disposed between the first annular wall and the central tube.

Preferably, the upper end cover includes a third annular wall inserted into the second annular wall, and a sealing ring is disposed between the second annular wall and the third annular wall.

Preferably, a sealing cover is disposed at the bottom of the filter cartridge cylinder, and a lifting handle is disposed on the sealing cover.

Preferably, a welding cover is disposed at the top of the filter cartridge cylinder, and openings corresponding to the first water gap, the second water gap and the third water gap respectively are formed in the welding cover.

By applying the above technical solution, compared with the prior art, the present utility model has the following advantages.

A coaxial central tube is disposed in a filter cartridge cylinder of a water purifier filter cartridge of simple structure of the present utility model; an RO membrane is wound outside the central tube; a pre-filtering membrane is wound outside the RO membrane; when raw water enters the central tube from the filter cartridge cylinder, the pre-filtering membrane is used for intercepting large-particle impurities in the water, the RO membrane is used for filtering out impurities such as inorganic salts, heavy metal ions, organic matter, bacteria and viruses, the pre-filtering membrane cooperates with the RO membrane, which effectively purifies the raw water, and improves the quality of drinking water; the RO membrane and the pre-filtering membrane are integrated into one piece without a plastic part for separation, so that the structure is simpler and the cost is lowered; the top of the filter cartridge cylinder is provided with three water gaps, which reduces the number of connecting ports, makes the connection of a water path of the filter cartridge in a water purifier more convenient, reduces mounting errors and omissions, improves the assembling efficiency, and further improves the structure of the water purifier filter cartridge.

### BRIEF DESCRIPTION OF THE DRAWINGS

The technical solution of the present utility model is further described below with reference to the accompanying drawings.

FIG. 1 is a three-dimensional view of a water purifier filter cartridge of simple structure of the present utility model;

FIG. 2 is a top view of the water purifier filter cartridge of simple structure of the present utility model;

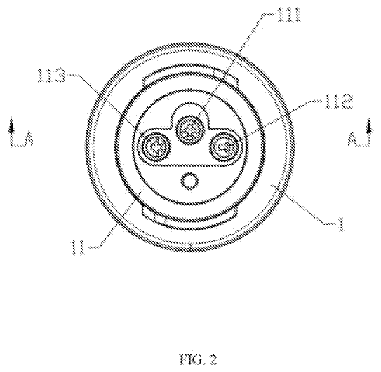

FIG. 3 is an A-A cross-sectional view of FIG. 2;

FIG. 4 is a partially enlarged view of position B of FIG. 3; and

FIG. 5 is a schematic view of a hidden filter cartridge body of the water purifier filter cartridge of simple structure of the present utility model.

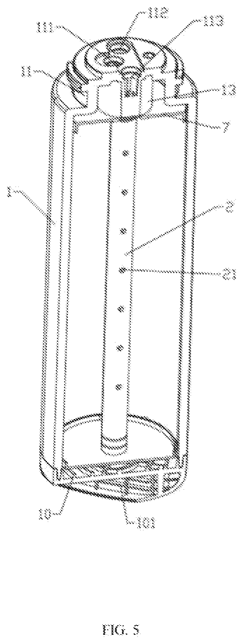

In the drawings: 1: filter cartridge cylinder: 11: boss; 111: first water gap; 112: second water gap; 113: third water gap; 12: first anular wall; 13: second annular wall; 2: central tube; 21: water hole; 3: first cavity; 41: RO membrane; 42: pre-filtering membrane; 5: second cavity; 6: lower end cover; 7: upper end cover; 71: third annular wall; 8: third cavity; 9: sealing ring; 10: sealing cover; 101: lifting handle; 20: welding cover.

### DETAILED DESCRIPTION

Preferred embodiments of the present utility model will be described in detail below with reference to the accompanying drawings so as to make the advantages and features of the present utility model be understood by those skilled in the art more easily, so that the scope of protection of the present utility model can be defined more clearly.

It should be noted that, when a component is referred to as “being fixed to” another component, the component may be directly on the another component, or an intermediate component may be present. When a component is referred to as “being connected to” another component, the component may be directly connected to the another component, or an intermediate component may be present. When a component is referred to as “being disposed on” another component, the component may be directly disposed on the another component, or an intermediate component may be present. The terms “vertical”. “horizontal”, “left”, “right”, and similar expressions used in this text are only for purposes of illustration.

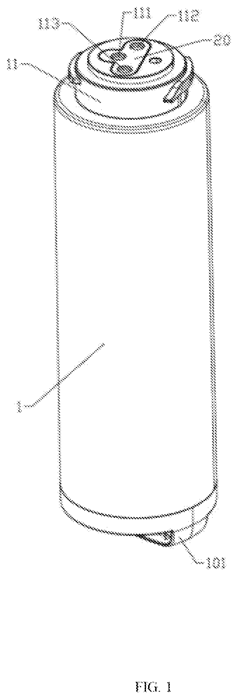

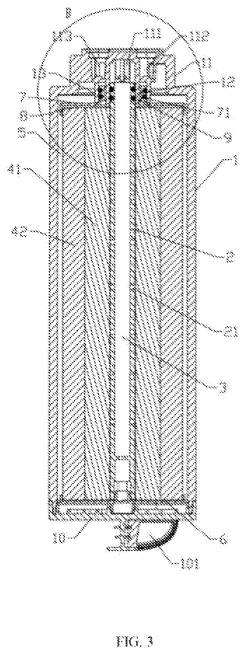

As shown in FIG. 1, it is a water purifier filter cartridge of simple structure of the present utility mode, including, a filter cartridge cylinder 1. As shown in FIG. 3, a central tube 2 coaxial with the filter cartridge cylinder 1 is mounted in the filter cartridge cylinder 1, the bottom of the central tube 2 is sealed, and a first cavity 3 is formed in the central tube 2. A filter cartridge body is mounted outside the central tube 2; the filter cartridge body includes an RO membrane 41 and a pre-filtering membrane 42; the pre-filtering membrane 42 is used for intercepting large-particle impurities in water; the RO membrane 41 is used for filtering out impurities such as inorganic salts, heavy metal ions, organic matter, bacteria and viruses. The surface of the central tube 2 is wound and coated with the RO membrane 41, and several water holes 21 communicating the first cavity 3 with the RO membrane 41 are uniformly arranged in the side wall of the central tube 2 so that water permeating through the RO membrane 41 can enter the central tube 2 through the water hole 21. The pre-filtering membrane 42 is wound outside the RO membrane 41, a second cavity 5 is formed between the pre-filtering membrane 42 and the filter cartridge cylinder 1, and raw water entering the filter cartridge body 1 first enters the second cavity 5, and then permeates through the pre-filtering membrane 42 and the RO membrane 41 in sequence to enter the first cavity 3.

A lower end cover 6 is mounted at the bottom of the filter cartridge body, and an upper end cover 7 is mounted at the top of the filter cartridge body so that the filter cartridge body is fixed in the filter cartridge cylinder 1. A third cavity 8 is formed between the upper end cover 7 and the filter cartridge body. A boss 11 is formed at the top of the filter cartridge cylinder 1; a first water gap 111, a second water gap 112 and a third water gap 113 are formed in the boss 11; the first water gap 111 communicates with the first cavity 3; the second water gap 112 communicates with the second cavity 5; and the third water gap 113 communicates with the third cavity 8. The raw water enters the second cavity 5 from the second water gap 112, enters the first cavity 3 of the central tube 2 after passing through the pre-filtering membrane 42 and the RO membrane 41 for double filtration, and leaves from the first water gap 11I.

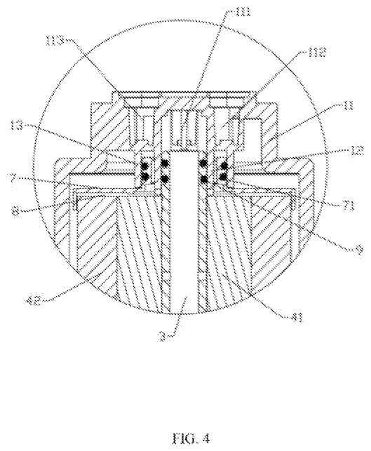

As shown in FIG. 4, a first annular wall 12 and a second annular wall 13 coaxial with the filter cartridge cylinder 1 are formed in the boss 11, the upper portion of the central tube 2 is inserted into the first annular wall 12, and a sealing ring 9 is mounted between the first annular wall 12 and the central tube 2, which avoids that the water in the first cavity 3 is mixed with the water in the third cavity 8. The upper end cover 7 includes a third annular wall 71 inserted into the second annular wall 13, and a sealing ring 9 is mounted between the second annular wall 13 and the third annular wall 17, which improves the sealing performance of products.

A sealing cover 10 is mounted at the bottom of the filter cartridge cylinder 1, and the sealing cover 10 is integrally provided with a lifting handle 101, which facilitates holding during mounting and disassembling. A welding cover 20 is mounted at the top of the filter cartridge cylinder 1, and openings corresponding to the first water gap 111, the second water gap 112 and the third water gap 113 respectively are formed in the welding cover 20.

According to the water purifier filter cartridge of simple structure of the present utility model, the RO membrane 41 and the pre-filtering membrane 42 are integrated into one piece without a plastic part for separation, only one central tube 2 is disposed, so that the structure is simpler, mounting is more convenient, and the labor cost and the material cost are reduced. The three water gaps are formed in the top of the filter cartridge cylinder 1, which reduces the number of connecting ports, so that connection of a water path of the filter cartridge in a water purifier is more convenient, mounting errors and omissions are reduced, the assembling efficiency is improved, and the structure of the water purifier filter cartridge is further improved.

What is described above is merely embodiments of the present utility model, and the patent scope of the present utility model is not limited thereto. All equivalent structure or process changes made according to the content of the description of the present utility model or directly or indirectly applying the present utility model in other related technical fields shall fall within the protection scope of the present utility model.

1. A water purifier filter cartridge of simple structure, comprising, a filter cartridge cylinder, a central tube coaxial with the filter cartridge cylinder being disposed in the filter cartridge cylinder; a first cavity being formed in the central tube; a filter cartridge body being disposed outside the central tube; the filter cartridge body comprising an RO membrane and a pre-filtering membrane; the RO membrane being wound around the central tube; several water holes communicating the first cavity with the RO membrane being formed in the side wall of the central tube; the pre-filtering membrane being wound outside the RO membrane; a second cavity being formed between the pre-filtering membrane and the filter cartridge cylinder; a lower end cover being disposed at the bottom of the filter cartridge body, an upper end cover being disposed at the top of the filter cartridge body, and a third cavity being formed between the upper end cover and the filter cartridge body; a first water gap, a second water gap and a third water gap being formed in the top of the filter cartridge cylinder; the first water gap communicating with the first cavity; the second water gap communicating with the second cavity; and the third water gap communicating with the third cavity.

2. The water purifier filter cartridge of simple structure according to claim 1, wherein a boss is disposed at the top of the filter cartridge cylinder, and the first water gap, the second water gap and the third water gap are formed in the boss.

3. The water purifier filter cartridge of simple structure according to claim 2, wherein a first annular wall and a second annular wall coaxial with the filter cartridge cylinder are disposed in the boss, the upper portion of the central tube is inserted into the first annular wall, and a sealing ring is disposed between the first annular wall and the central tube.

4. The water purifier filter cartridge of simple structure according to claim 3, wherein the upper end cover comprises a third annular wall inserted into the second annular wall, and a sealing ring is disposed between the second annular wall and the third annular wall.

5. The water purifier filter cartridge of simple structure according to claim 1, wherein a sealing cover is disposed at the bottom of the filter cartridge cylinder, and a lifting handle is disposed on the sealing cover.

6. The water purifier filter cartridge of simple structure according to claim 1, wherein a welding cover is disposed at the top of the filter cartridge cylinder, and openings corresponding to the first water gap, the second water gap and the third water gap respectively are formed in the welding cover.
